(19) United States
(12) Patent Application Publication
(10) Pub. No.: US 2002/0090885 A1
(43) Pub. Date: Jul. 11, 2002

(54) Flange connection

(76) Inventor: Volker Wendt, Goteborg (SE)

Correspondence Address: Ronald L. Grudziecki, Esquire, BURNS, DOANE, SWECKER & MATHIS, L.L.P., P.O. Box 1404, Alexandria, VA, 22313-1404, US

(21) Appl. No.: 10/022,344

(22) Filed: Dec. 20, 2001

(30) Foreign Application Priority Data
Dec. 20, 2000 (SE) 0004770-4

(51) Int. Cl. B24B 49/00; F16C 32/06

(52) U.S. Cl. 451/5; 451/24; 451/402; 384/100

(57) ABSTRACT

A flange connection is adapted for interconnecting a rotary spindle and a substantially ring-formed member in such a manner that the ring-formed member is well centered about the axis of the spindle. The spindle has a surface which is well centered about the axis of the spindle and the ring-formed member has an axially projecting sleeve-shaped flange. The flange has in its inner envelope surface an annular bulge that is arranged to enclose and engage the spindle surface centered about the spindle axis.

This application is based on and claims priority under 35 U.S.C. § 119 with respect to Swedish Application No. 0004770-4 filed on Dec. 20, 2000, the entire content of which is incorporated herein by reference.

### FIELD OF THE INVENTION

The present invention generally relates to a flange connection. More particularly, the present invention pertains to a flange connection primarily used for centering a machine element on a cylindrical surface, e.g., on a rotary shaft journal or a spindle.

### BACKGROUND OF THE INVENTION

In many mechanical fields and particularly with respect to apparatus or machines running at high speeds, it is very important to reduce as much as possible the vibrations caused by any unbalance in order to prevent the apparatus or machine and/or the person handling the apparatus or machine from being subjected to vibrations that can cause damage or injuries.

In recent years automatic balancing devices have been used for reducing such vibrations. These balancing devices are of the type having an annular housing with an internal race in which are freely movable a number of balancing bodies for positioning themselves along the race so that the tendencies of unbalance are counteracted. To provide a good result, it is very important that such an automatic balancing unit be mounted in a positively centered position around the rotational axis of the shaft journal. An application where such an automatic balancing unit is very well suited is in connection with hand-held angle grinders, which operate at high rotational speed. For such a tool, it is very important that the tool transfer as little vibration as possible to the person using the tool, as such vibrations will reduce the time the tool can be used without risking injuries to the operator.

Such angle grinders have a spindle, often with a key flange, which is a part-cylindrical surface, interrupted by two opposed flat surfaces. This key flange is particularly suited for being machined in such a manner that a true centered, mainly cylindrical surface is obtained and this surface is appropriate for supporting such an automatic balancing unit. However the mounting of the annular housing of the automatic balancing device requires that the contact surfaces on the housing and the spindle part thus machined to be true cylindrical have closely matching tolerances for contacting each other positively. If the closely matching tolerance situation is not successfully obtained, the assembly of the automatic balancing device and the angle grinder is not possible without destroying one of the such members or without obtaining the needed and desired centricity or centering.

### SUMMARY OF THE INVENTION

According to the present invention, a flange connection is provided which reduces or eliminates the problem described above and does not require very closely matching tolerances of the surfaces. The flange connection nevertheless guarantees that the detail mounted on the centric, cylindrical surface will be well centered.

In accordance with one aspect of the invention, a flange connection interconnects a rotary spindle and a substantially ring-shaped member in such a manner that the ring-shaped member is centered about the axis of the spindle. The spindle has a surface which is centered about the axis of the spindle, and the ring-shaped member has an axially projecting sleeve-shaped flange possessing an inner surface provided with an annular bulge. The annular bulge is arranged to enclose and engage the surface of the spindle that is centered about the axis of the spindle.

Another aspect of the invention involves a spindle in combination with an automatic balancing device. The automatic balancing device includes an annular housing having an annular passageway and a plurality of balancing bodies positioned in the annular passageway. The spindle has a center axis and a surface which is centered about the center axis of the spindle. The annular housing is mounted on the spindle so that the annular housing is centered about the center axis of the spindle, with the housing being provided with an axially projecting annular flange possessing a surface facing the surface of the spindle which is centered about the center axis of the spindle. The surface of the flange is provided with an annular bulge engaging the surface of the spindle that is centered about the axis of the spindle.

### BRIEF DESCRIPTION OF THE DRAWING FIGURES

The foregoing and additional features and characteristics of the present invention will become more apparent from the following detailed description considered with reference to the accompanying drawing figures in which like reference numerals designate like elements.

FIG. 1 is a side view, partly in cross-section, of a known flange connection prior to mounting.

FIG. 2 is a side view of the flange connection shown in FIG. 1 during mounting.

FIG. 3 is a side view, partly in cross-section, of a flange connection according to the present invention.

FIG. 4 is a perspective view, partly in cross-section, of a flange connection of the type shown in FIG. 3, with the flange connection incorporated in a housing of an automatic balancing device.

FIG. 5 is a cross-sectional view through a half of a somewhat modified automatic balancing device having an integrated flange for a flange connection in accordance with the present invention.

FIG. 6 is a perspective view, partly in cross-section, of a spindle of a angle grinder provided with an automatic balancing device mounted to the spindle by way of a flange connection in accordance with the present invention.

### DETAILED DESCRIPTION OF THE INVENTION

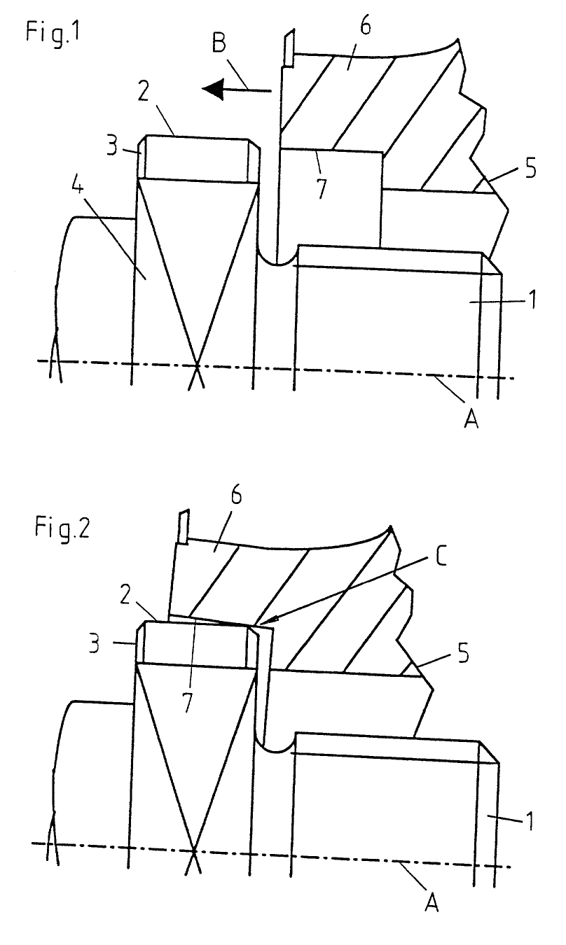

FIG. 1 illustrates a part of a spindle 1 having a center axis A about which has been machined an accurately centered part cylindrical surface 2, which in the illustrated embodiment is a surface of a key flange 3, for example of a spindle for an angle grinder, and which is substantially cylindrical but has two opposed planar surfaces 4, thereby forming a part-cylindrical component, wherein the cylindrical portions of the component are precisely centered about the axis A. According to this known construction, the detail 5 to be attached to the spindle has a flange portion 6 provided with a machined cylindrical bore surface 7 intended to have a close fit relative to the cylindrical part of the surface 2. The detail 5 is mounted on the surface 2 by being pushed up with a force represented by the arrow B.

However, any deviation in tolerances between the two contact surfaces 2, 7, or a tipping movement of the detail 5, causes the flange portion 6 of the detail 5 to be distorted as illustrated at C in FIG. 2, thereby resulting in the centering surfaces not overlying each other. This causes an incorrect positioning of the detail, resulting in an imprecise centric or centered location on the spindle. Alternatively, the difference can be such that there is an undesired clearance between the surfaces.

FIG. 3 is an illustration of how this problem, experienced with the known construction shown in FIGS. 1 and 2, can be addressed in accordance with the present invention. The illustrated embodiment of the flange connection according to the present invention is shown with a spindle 1 having a surface 2 on a key flange 3, that has been machined, for example turned and/or ground to be precisely centric or centered about the center axis A. A detail 5 having a projecting flange 6 is to be mounted on the key flange 3. However, the bore surface or inner surface of the flange 6 is not made to possess a cylindrical shape like the surface 7 in the known construction according to FIGS. 1 and 2. Instead, the inner bore surface 8 is provided with an annular bulge 9 which contacts the cylindrical, precisely centered key flange surface 2. The projecting sleeve-shaped flange is substantially thinner than the detail of which it is an integrated part. In this manner, the flange portion 6 of the detail 5 has proven itself to permit a certain degree of deformation while at the same time always with line-contact maintaining its centering contact against the flange surface 2 of the spindle 1. It has been found that the sleeve-shaped flange 6 can be easily pushed up on the centering surface 2 of the spindle flange 3 due to its flexibility. Surprisingly, it has been found that the circumferential engagement between the centering surface 2 and the annular bulge 9 keeps the detail 5 well centered without giving rise to throws or other types of uneven operation. In the illustrated embodiment, the bulge 9 has a contact surface facing and engaging the surface of the spindle which is centered about the axis of the spindle. This contact surface of the bulge possesses a substantially circular curvature.

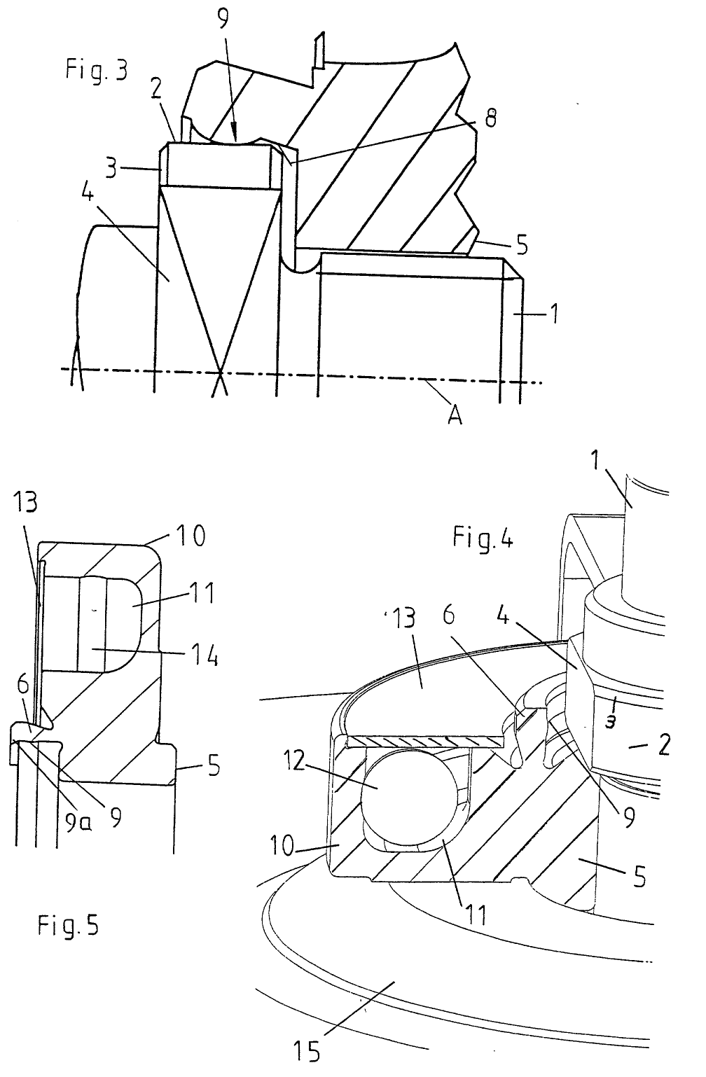

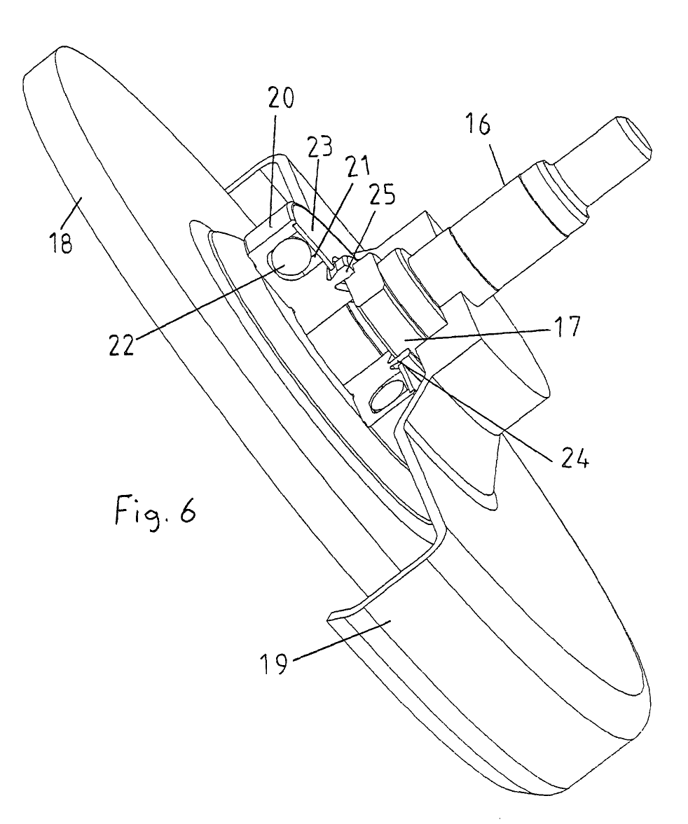

Although not being limited in this regard, the flange connection according to the present invention is particularly suited to be used for attaching a housing of an automatic balancing unit about the spindle of an angle grinder. Such an application is illustrated in FIGS. 4 and 6.

FIG. 4 is a perspective view a portion of an angle grinder, partly in cross-section, with a portion of a spindle 1 having a key flange 3 with a cylindrical outer surface 2 which has been machined in any suitable manner to be accurately centered about the geometrical longitudinal axis of the spindle. The key flange 3 has planar portions 4, only one of which is illustrated in FIG. 4. A detail 5, in this embodiment in the form of a housing 10 for an automatic balancing unit, is mounted on the spindle. The housing 10 is provided with an axially projecting, sleeve-shaped flange 6, resembling that of the embodiment shown in FIG. 3. An annular bulge 9 corresponding to the bulge shown in the embodiment of FIG. 3 is provided on the inner surface of this sleeve-shaped flange 6. The bulge 9 engages the perfectly centered, part-cylindrical outer surface 2 of the key-grip flange of the spindle 1. It is to be noted that the size of the bulge 9 shown in FIG. 3 has been somewhat exaggerated for clarity reasons, whereas the corresponding bulge in the embodiment of FIG. 4, is more proportional.

The automatic balancing device comprises, in the housing 10, an annular space 11 in which is contained a number of freely movable balancing bodies 12. In the illustrated embodiment, the balancing bodies are in the form of balls. These balancing bodies, during rotation of the housing 10 which rotates together with the spindle, strive to assume positions in which they together out-balance or counteract any imbalance in the spindle 1 and its associated members, such as an attached grinding disc. The annular space 11 is closed off by a lid 13. When the housing 10 is mounted on the spindle, the annular bulge 9 will be in contact with the surface 2 of the flange 3, which is carefully centered about the rotational axis A of the spindle 1, with the housing 10 thereby also being perfectly centered about the axis to ascertain that a satisfactory automatic balancing effect will be obtained. It has proven to be that the sleeve-shaped flange 6 will give a relatively very reliable and efficient centering of the housing 10, probably due to the flexibility of the comparatively thin sleeve-shaped flange. FIG. 4 also illustrates a portion of a grinding disc 15 mounted on the spindle 1 of an angle grinder equipped with the balancing device.

Another advantage associated with the design as shown is the use of a part-cylindrical surface 3 (i.e., the cylinder form cut off by two opposed planar segments for the key-grip) is that the engagement between the bulge 9 and the accurately part-cylindrical surface 2 will be less rigid, whereby it will be more easy to push up the housing 10 on the spindle 1 without risking that it breaks.

FIG. 5 illustrates in cross-section a half of the integrated detail 5 and balancing device housing 10 shown in FIG. 4. As illustrated in FIG. 5, an internal groove 14 is provided in the annular space in the housing to form a track for the balancing bodies. In FIG. 5, the balancing bodies are not shown. The sleeve-formed flange 6 can additionally be equipped with an edge 9a on the inner side of the flange. This edge 9a can be milled away over a width corresponding to the wrench surfaces on the flange 2 for making possible the entering of the part-cylindrical surfaces, with the additional gain of a form-fit to withstand torsional forces.

FIG. 6 illustrates a spindle 16 of an angle grinder having a portion with an at least part-cylindrical surface 17 which has been machined to be accurately centric or centered to the longitudinal center axis of the spindle. At one end, the spindle carries a grinding disc 18 which is partly enclosed by a casing 19. Between the grinding disc 18 and the surface 17 is provided a housing 20 of an automatic balancing unit in which is provided an annular space 21 housing a number of balancing bodies 22. The annular space 21 is closed off by way of a lid 23.

Integral with the housing 20 is a relatively thin-walled annular flange 24 which is sleeve-formed and projects axially from the housing. At the outer end, remote from the housing 20, the sleeve-formed flange 24 is equipped with an annular bulge 25 on its inner surface facing towards the flange surface 17. This annular bulge engages the accurately centered flange surface 17 and causes the housing 20 of the automatic balancing unit to be accurately centered about the spindle 16.

The flange connection according to the present invention has been described in connection with the embodiments shown in the drawing figures as a mechanism for accurately centering a housing of an automatic balancing unit on the spindle of an angle grinder. It is evident, however, that the same advantages and effect can be obtained also in other cases where a substantially ring-formed member is to be accurately attached in a well centered manner to a rotary spindle.

The principles, preferred embodiments and modes of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A flange connection interconnecting a rotary spindle having an axis and a substantially ring-shaped member in such a manner that the ring-shaped member is centered about the axis of the spindle, the spindle having a surface which is centered about the axis of the spindle, the ring-shaped member having an axially projecting sleeve-shaped flange possessing an inner surface provided with an annular bulge, the annular bulge being arranged to enclose and engage the surface of the spindle that is centered about the axis of the spindle.

2. The flange connection according to claim 1, wherein the surface of the spindle which is centered about the axis of the spindle is a part-cylindrical surface having portions that are cylindrical, the annular bulge engaging only the portions of the part-cylindrical surface that are cylindrical.

3. The flange connection according to claim 2, wherein the sleeve-shaped flange is an integrated part of the ring-shaped member.

4. The flange connection according to claim 3, wherein the ring-shaped member constitutes a housing of an automatic balancing unit, the ring-shaped member including an annular closed off chamber forming a race track for receiving balancing bodies adapted to compensate unbalance in at least the spindle.

5. The flange connection according to claim 4, wherein the spindle is the spindle of an angle grinder, the spindle being attached to a grinding disc, and the housing of the automatic balancing unit being provided between the surface of the spindle which is centered about the axis of the spindle and the grinding disc.

6. The flange connection according to claim 5, wherein the bulge has a contact surface facing and engaging the surface of the spindle which is centered about the axis of the spindle, the spindle having a substantially circular curvature.

7. The flange connection according to claim 6, wherein the sleeve-shaped flange has an inwardly facing edge providing a form-fitting attachment for the sleeve-shaped flange on the spindle.

8. The flange connection according to claim 1, wherein the sleeve-shaped flange is an integrated part of the ring-shaped member.

9. The flange connection according to claim 1, wherein the ring-shaped member constitutes a housing of an automatic balancing unit, the ring-shaped member including an annular closed off chamber forming a race track for receiving balancing bodies adapted to compensate unbalance in at least the spindle.

10. The flange connection according to claim 1, wherein the spindle is the spindle of an angle grinder, the spindle being attached to a grinding disc, and the housing of the automatic balancing unit being provided between the surface of the spindle which is centered about the axis of the spindle and the grinding disc.

11. The flange connection according to claim 1, wherein the bulge has a contact surface facing and engaging the surface of the spindle which is centered about the axis of the spindle, the spindle having a substantially circular curvature.

12. The flange connection according to claim 1, wherein the sleeve-shaped flange has an inwardly facing edge providing a form-fitting attachment for the sleeve-shaped flange on the spindle.

13. A spindle in combination with an automatic balancing device, the automatic balancing device comprising an annular housing having an annular passageway and a plurality of balancing bodies positioned in the annular passageway, the spindle having a center axis and a surface which is centered about the center axis of the spindle, the annular housing being mounted on the spindle so that the annular housing is centered about the center axis of the spindle, the housing being provided with an axially projecting annular flange possessing a surface facing the surface of the spindle which is centered about the center axis of the spindle, the surface of the flange being provided with an annular bulge engaging the surface of the spindle that is centered about the center axis of the spindle.

14. The combination according to claim 13, wherein the surface of the spindle which is centered about the axis of the spindle is a part-cylindrical surface having portions that are cylindrical, the annular bulge engaging only the portions of the part-cylindrical surface that are cylindrical.

15. The combination according to claim 13, wherein the annular flange is an integrated part of the housing.

16. The combination according to claim 13, wherein the spindle is attached to a grinding disc.

17. The combination according to claim 16, wherein the housing is positioned between the surface of the spindle which is centered about the axis of the spindle and the grinding disc.

18. The combination according to claim 13, wherein the bulge has a contact surface facing and engaging the surface of the spindle which is centered about the axis of the spindle, the contact surface having a substantially circular curvature.

19. The combination according to claim 13, wherein the flange has an inwardly facing edge providing a form-fitting attachment for the flange on the spindle.
